(19) United States
(12) Patent Application Publication
(10) Pub. No.: US 2020/0118122 A1
(43) Pub. Date: Apr. 16, 2020

(54) TECHNIQUES FOR COMPLETING MISSING AND OBSCURED TRANSACTION DATA ITEMS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 16/600,783

(22) Filed: Oct. 14, 2019

Related U.S. Application Data
(60) Provisional application No. 62/745,487, filed on Oct. 15, 2018.
(60) Provisional application No. 62/754,100, filed on Nov. 1, 2018.

(51) Int. Cl. G06Q 20/38; G06N 20/00; G06K 9/00; G06F 16/25

(52) U.S. Cl. CPC G06Q 20/389; G06F 16/258; G06K 9/00469; G06N 20/00

(57) ABSTRACT

A system and method completing missing transaction data items, including: determining a first template for a first transaction evidence based on an analysis of an electronic image, wherein the electronic image includes at least the first transaction evidence and a second transaction evidence, wherein the first transaction evidence is partially obscured by the second transaction evidence; comparing the first template to a plurality of templates of previous transaction evidences; determining, based on the comparison, at least a second template of the plurality of templates that is similar to the first template above a predetermined threshold; determining at least a type of a missing transaction data item (TDI) that exists in the second template and does not exist in the first template; retrieving at least a complementary TDI based on at least the determined type of the missing TDI; and associating the at least a complementary TDI with the electronic image.

### CROSS-REFERENCE TO RELATED APPLICATIONS

This application claims the benefit of U.S. Provisional Application No. 62,745,487 filed on Oct. 15, 2018, and of U.S. Provisional Application No. 62/754,100 filed on Nov. 1, 2018. The contents of the aforementioned applications are hereby incorporated by reference.

### TECHNICAL FIELD

The present disclosure relates generally to processing electronic documents and transactions, and more specifically to completing missing and obscured transaction data items within electronic documents.

### BACKGROUND

As many businesses operate internationally, expenses made by employees are often recorded from various jurisdictions. The tax paid on many of these expenses can be reclaimed, such as the those paid toward a value added tax (VAT) in a foreign jurisdiction. Typically, when a VAT reclaim is submitted, evidence in the form of documentation related to the transaction (such as an invoice, a receipt, level 3 data provided by an authorized financial service company, and the like) must be recorded and stored for future tax reclaim inspections. In other cases, the evidence must be submitted to an appropriate refund authority (e.g., a tax agency of the country refunding the VAT) to allow for the VAT refund.

The content of the evidences must be analyzed to determine the relevant information contained therein. This process traditionally had been done manually by an employee reviewing each evidence individually. This manual analysis introduces potential for human error, as well as obvious inefficiencies and expensive use of manpower. Existing solutions for automatically verifying transaction data face challenges in utilizing electronic documents containing at least partially unstructured data.

Automated data extraction and analysis of content objects executed by a server enables automatically analyzing evidences and other documents. The automated data extraction provides a number of advantages. For example, such an automated approach can improve the efficiency, accuracy and consistency of processing. However, such automation relies on being able to appropriately identify which data elements are to be extracted for subsequent analysis, which is can often be challenging due to imperfections with the input documentation.

Specifically, in many cases when employees capture a transaction evidence, such as a tax receipt, the evidence is obscured by another document, e.g., a credit card slip that is often attached to the tax receipt by the vendor representative. Therefore, in many cases credit card slips or similar documents obscure the first transaction evidence such that the first transaction evidence lacks important and necessary information.

Further, once a transaction evidence has been properly identified, it often is desirable to associate the evidence to a correlated record, such as an expense report, booking information, and the like. Such an association should happen only if the correlation can be determined above a predetermined threshold. Current solutions fail to provide an efficient way to associate transaction evidences with the matching correlated record.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for completing missing transaction data items, including: determining a first template for a first transaction evidence based on an analysis of an electronic image, wherein the electronic image includes at least the first transaction evidence and a second transaction evidence, wherein the first transaction evidence is partially obscured by the second transaction evidence; comparing the first template to a plurality of templates of previous transaction evidences; determining, based on the comparison, at least a second template of the plurality of templates that is similar to the first template above a predetermined threshold; determining at least a type of a missing transaction data item (TDI) that exists in the second template and does not exist in the first template; retrieving at least a complementary TDI based on at least the determined type of the missing TDI; and associating the at least a complementary TDI with the electronic image.

Certain embodiments disclosed herein also include non-transitory computer readable medium having stored thereon instructions for causing a processing circuitry to perform a process, the process including: determining a first template for a first transaction evidence based on an analysis of an electronic image, wherein the electronic image includes at least the first transaction evidence and a second transaction evidence, wherein the first transaction evidence is partially obscured by the second transaction evidence; comparing the first template to a plurality of templates of previous transaction evidences; determining, based on the comparison, at least a second template of the plurality of templates that is similar to the first template above a predetermined threshold; determining at least a type of a missing transaction data item (TDI) that exists in the second template and does not exist in the first template; retrieving at least a complementary TDI based on at least the determined type of the missing TDI; and associating the at least a complementary TDI with the electronic image.

Certain embodiments disclosed herein also include a system for completing missing transaction data items, including: a processing circuitry; and a memory, the memory containing instructions that, when executed by the processing circuitry, configure the system to: determine a first template for a first transaction evidence based on an analysis of an electronic image, wherein the electronic image includes at least the first transaction evidence and a second transaction evidence, wherein the first transaction evidence is partially obscured by the second transaction evidence; compare the first template to a plurality of templates of previous transaction evidences; determine, based on the comparison, at least a second template of the plurality of templates that is similar to the first template above a predetermined threshold; determine at least a type of a missing transaction data item (TDI) that exists in the second template and does not exist in the first template; retrieve at least a complementary TDI based on at least the determined type of the missing TDI; and associate the at least a complementary TDI with the electronic image.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example network diagram utilized to describe the various disclosed embodiments.

FIG. 2 is an example schematic diagram of the server according to an embodiment.

FIG. 3 is an example flowchart illustrating a method for completing missing transaction data items of a transaction evidence that is partially obscured according to an embodiment.

FIG. 4 is an example flowchart illustrating an alternative method for completing missing transaction data items of a transaction evidence that is partially obscured according to an embodiment.

FIG. 5 is an example flowchart illustrating a method for associating a first transaction evidence stored in an electronic message to a correlated record according to an embodiment.

FIG. 6 is an example flowchart illustrating a method for creating a structured dataset template based on an electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed method analyzes electronic images that capture a first transaction evidence and a second transaction evidence, that obscures the first transaction evidence, for completing transaction data items that are missing from the first transaction evidence.

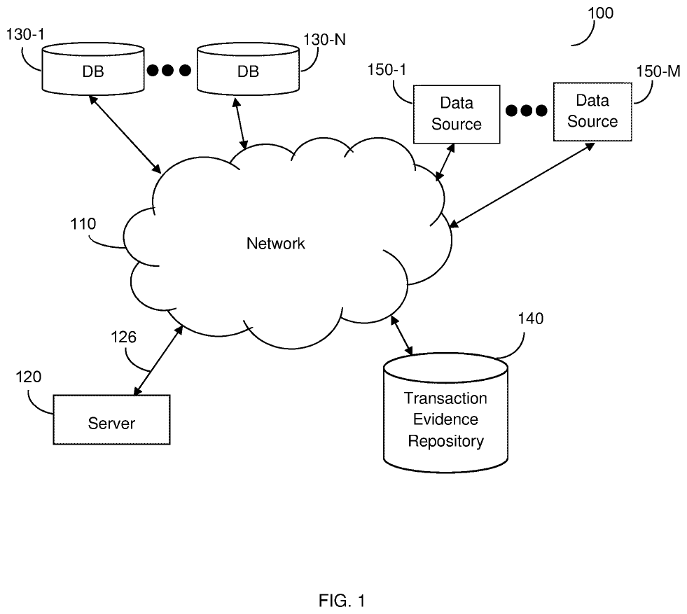

FIG. 1 shows an example network diagram 100 utilized to describe the various disclosed embodiments. In the example network diagram 100, a server 120, a transaction evidence repository 130, a plurality of databases 140-1 through 140-N (hereinafter referred to individually as a database 140 and collectively as databases 140, merely for simplicity purposes), and a plurality of data sources 150-1 through 150-M (hereinafter referred to individually as a data source 150 and collectively as data sources 150, merely for simplicity purposes) are communicatively connected via a network 110, where N and M are integers equal to or greater than 1. The network 110 may be, but is not limited to, a wireless, cellular or wired network, a local area network (LAN), a wide area network (WAN), a metro area network (MAN), the Internet, the worldwide web (WWW), similar networks, and any combination thereof.

The server 120 is connected to the network 110 using a network interface 126. In an embodiment, the server 120 is a combination of computer hardware and computer software components configured to execute predetermined computing tasks as further described herein below.

The transaction evidence repository 140 may include a plurality of images. Such images may include, but is not limited to, evidentiary electronic documents including information related to transactions. The evidentiary electronic documents may include, but are not limited to, invoices, receipts, and the like. In an embodiment, such images may include a first transaction evidence and a second transaction evidence.

The database 130 may be configured to store images of transaction evidences that were previously analyzed. The previously analyzed images may include templates that were determined based on regions of interest (ROI) identification, allowing to identify different types of templates that may be related to different entities, e.g. vendors. A plurality of images stored in the database 140 may be utilized for the purpose of comparing an image having a first template to the plurality of images for determining similarity between the image and at least one image of the plurality of images based on their templates.

The data source 150 may be a website, a data warehouse, a cloud database, and the like that is configured to contain information that is related to one or more transactions made using, for example, credit cards, PayPal®, Google® Pay, or other payment methods. The data source 150 may contain complementary transaction information, i.e., complementary transaction data items, as further described herein below.

In an embodiment, the server 120 is configured to receive an electronic image that captures at least a first transaction evidence and at least a second transaction evidence, where the first transaction evidence is partially, but not completely, obscured by the second transaction evidence. The first transaction evidence may be, for example, an invoice, a tax receipt, and so on. The second transaction evidence may be, for example, a credit card slip that in many cases is attached to the first evidence such that it obscures a portion of the information of the first evidence.

In an embodiment, the server 120 may be configured to determine, based on an analysis of the electronic image, a first template for the first transaction evidence. The analysis of the electronic image may include extracting a first set of transaction data items from the first transaction evidence and a second set of transaction data items from the second transaction evidence, using, for example, optical character recognition (OCR) technique, machine learning, and the like. The first set of transaction data items may include, e.g., a vendor name, a client name, an address, a transaction amount, and the like. The second set of transaction data items may include information, such as a vendor name, the last 4 digits of a credit card number, a transaction amount, a transaction date, and so on. In an embodiment, the analysis further enables to differentiate between the first transaction evidence and the second transaction evidence using, for example, a machine learning technique.

In an embodiment, the server 120 is configured to compare the first template to a plurality of templates of previous transaction evidences that are stored in a database, e.g. transaction evidence repository 140. Each of the plurality of templates may be associated with one or more entities. The entities may be, for example, vendors such as hotels, car rental companies, car service companies, airlines, restaurants, and so on.

In an embodiment, the server 120 is configured to determine, based on the comparison, at least a second template of the plurality of templates that is similar above a predetermined threshold to the first template. The predetermined threshold may indicate, e.g., that at least four regions of interest must be located at the same location for determining similarity between two templates.

In an embodiment, the server 120 is further configured to determine at least a type of a missing transaction data item that exists in the second template and does not exist in the first template. The types of transaction data items of the second template may be previously determined and associated with each data item of the second templates when stored in, e.g. the database 140. Thus, when a second template is determined to be similar above a predetermined threshold to a first template, one or more missing types of transaction data items may be determined by eliminating the types of transaction data items (that are associated with the transaction data items) that are already exist in the first template. The analysis enables to determine at least a type of transaction data items that are obscured by the second transaction evidence. The type of the transaction data items may be fields within a transaction evidence, for example, date, name of vendor, amount, and the like.

In an embodiment, the server 120 is configured to retrieve from at least a data source, e.g., the data source 150, at least a complementary transaction data item based on the type of the missing transaction data item. In an embodiment, retrieval of the complementary transaction data item is based on at least the type of the missing transaction data item, the first set of transaction data items and the second set of transaction data items. The complementary transaction data item is additional information that relates to the transaction to which the first transaction evidence is associated. For example, the complementary transaction data item may be a transaction date that does not exist in the first transaction evidence, e.g., was obscured by the second transaction evidence.

As an example, a missing vendor name may be retrieved from a database containing credit card transaction information. The retrieval may be achieved based on identification of the missing transaction data item type, e.g. a vendor name; the first set of transaction data items, e.g. a client name; a transaction date; and the like, and the second set of transaction data items, e.g. a transaction amount; the last four digits of a credit card number; and so on. For example, after determining that the date and the vendor name, e.g., the types of missing transaction data items, are missing from the first evidence, the server 120 may retrieve from a credit card company website the complementary transaction data item based on the transaction data items that exist in the first transaction evidence and in the second transaction evidence.

In an embodiment, the server 120 is configured to associate the at least a complementary transaction data item with the electronic image. The association may include generating a new database at which the electronic image is associated with the complementary transaction data item. In a further embodiment, each complementary transaction data item may be associated to a corresponding electronic image where the electronic image was previously stored.

According to another embodiment, the server 120 may be configured to analyze the electronic image, using for example, computer vision technique, such that the first transaction evidence as well as the second transaction evidence are identified, e.g., where each of them is identified as a different document. The server 120 is then configured to extract from each of the transaction data evidences the transaction data items that are present in each of them. The extraction may be achieved, for example, using optical character recognition (OCR) technique, at least one machine learning technique, and the like. The extracted transaction data items may be analyzed for determining whether one or more transaction data items are missing from the first transaction evidence. The determination whether one or more transaction data items are missing may be achieved by comparing the type of transaction data items that were extracted from the first transaction evidence and from the second transaction evidence, to a predetermined checklist, e.g. a regulatory requirements checklist. The predetermined checklist may include the type of information that must appear on a transaction evidence in order to, for example, get a full value added tax (VAT) reclaim for a certain transaction.

According to another embodiment, the server 120 is configured to retrieve the complementary transaction data item from the second transaction evidence upon determination of the type of the missing transaction data item. For example, when the first transaction evidence lacks the transaction date, the second transaction evidence may include this information and thus data item of the transaction date may be retrieved from the second transaction data item.

According to yet further embodiment, upon determination of the type of the missing transaction data item, the server 120 is further configured to retrieve the complementary transaction data item, e.g., from a data source such as the data source 150 of FIG. 1. The retrieval may be based on the type of the missing transaction data item and the first set of transaction data items. In an embodiment, the retrieval is performed without using the second set of transaction data items of the second transaction evidence.

In a further embodiment, the determination of the first template of the first transaction evidence may be achieved by identifying one or more regions of interest (ROI) in the first transaction evidence. Each region of interest may include one or more transaction data items such as a vendor name, a client name, an address, a transaction amount, and the like.

In a further embodiment, each template of the plurality of templates of previous transaction evidences may comprise an array of regions of interest. Each region of interest that is associated with at least one of the plurality of templates of previous transaction evidences may comprise at least a third set of transaction data items. The third set of transaction data items may include for example, a vendor name, a client name, an address, a transaction amount, and the like.

According to another embodiment, the second template determined to be similar above a predetermined threshold includes a full array of the regions of interest. A full array of regions of interest may be predetermined or identified by previously analyzing the previous transaction evidences, determining their completeness by preforming, for example, machine learning techniques, performing comparisons to other transaction evidences that were determined to include full arrays of regions of interest, and the like.

As a non-limiting example, in case the first template associated with the first transaction evidence contains four regions of interest, the second template determined to be similar above a predetermined threshold may include five regions of interest which represent a full array of regions of interest for a specific template. In a further embodiment, the second template determined to be similar above a predetermined threshold may also include four regions of interest but one of the regions of interest may be larger in the second template, contain more information, and the like, such that data items may still be missing from the first template. As a non-limiting example, the first template may include five regions of interest that are organized in a certain array that allow for the determination of a similarity above a predetermined threshold to a second template having six regions of interest, where five of the regions are organized in an identical array. The predetermined threshold may be established manually, e.g., by a user, or automatically, e.g., using machine learning techniques.

According to another embodiment, the server 120 is configured determine, based on the full array of the regions of interest of the second template, at least a portion of a region of interest that exists in the second template and that is missing from the first template of the first transaction evidence. The at least a portion of the region of interest may include one or more transaction data items such as a transaction date, a vendor name, a vendor address, a client name, and the like. As an example, after determining that two templates are similar above the predetermined threshold, by identifying five similar regions of interest that are organized at the same array, an additional region of interest related to the second template is used for determining what are the elements that are missing from the first template.

The determination of the at least a type of the missing transaction data item that exists in the second template and does not exist in the first template may be achieved by analyzing the at least a portion of a region of interest that exists in the second template and that is missing from the first template of the first transaction evidence, using, for example, OCR, machine learning technique, and so on.

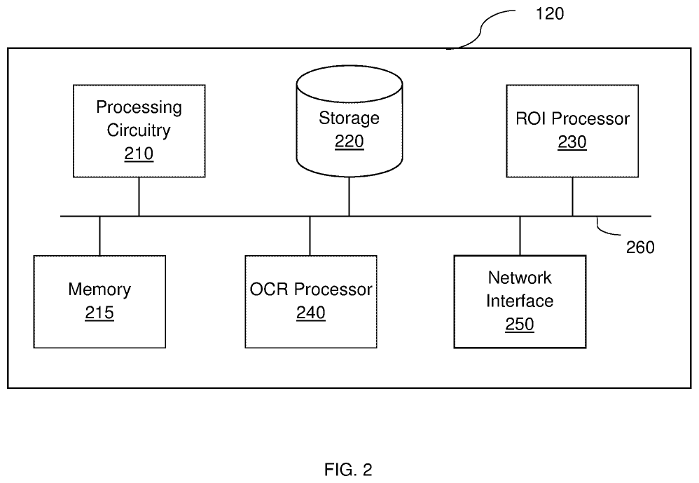

FIG. 2 is an example schematic diagram of the server 120 according to an embodiment. The server 120 includes a processing circuitry 210 coupled to a memory 215, a storage 220, an optional region of interest (ROI) processor 230, an optical character recognition (OCR) processor 240, and a network interface 250. In an embodiment, the components of the server 120 may be communicatively connected via a bus 260.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, and the like), non-volatile (e.g., ROM, flash memory, and the like), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processing circuitry 210, cause the processing circuitry 210 to perform the various processes described herein.

The storage 220 may be a magnetic storage, a solid state storage, an optical storage, and the like, and may be realized, for example, as flash memory or other memory technology, CD-ROM, Digital Versatile Disks (DVDs), or any other medium which can be used to store the desired information.

The optional ROI processor 230 may be configured to identify regions of interest in at least an image of an expense evidence. The ROI is an area in an electronic image of an expense evidence that contains information of interest, for example, a logo, a transaction total amount, a value added tax (VAT) amount, a vendor's name, a vendor's identification number, a vendor's address, and so on. Specifically, in an embodiment, the ROI processor 230 is configured to identify a plurality of ROIs in each image that includes a first transaction evidence as well as a second transaction evidence, such that an array of ROIs is determined and can be utilized to determine or generate a template for at least the first transaction evidence.

The OCR processor 240 may include, but is not limited to, a feature and/or pattern recognition unit (RU), not shown, configured to identify patterns, features, or both, in unstructured data sets. The OCR processor 240 may be configured to extract transaction data items from the first transaction evidence and from the second transaction evidence.

The network interface 250 allows the server 120 to communicate with the transaction evidence repository 130, the database 140, for the purpose of, for example, retrieving data, storing data, data sources 150, and the like through the network 110, each of FIG. 1.

It should be understood that the embodiments described herein are not limited to the specific architecture illustrated in FIG. 2, and other architectures may be equally used without departing from the scope of the disclosed embodiments.

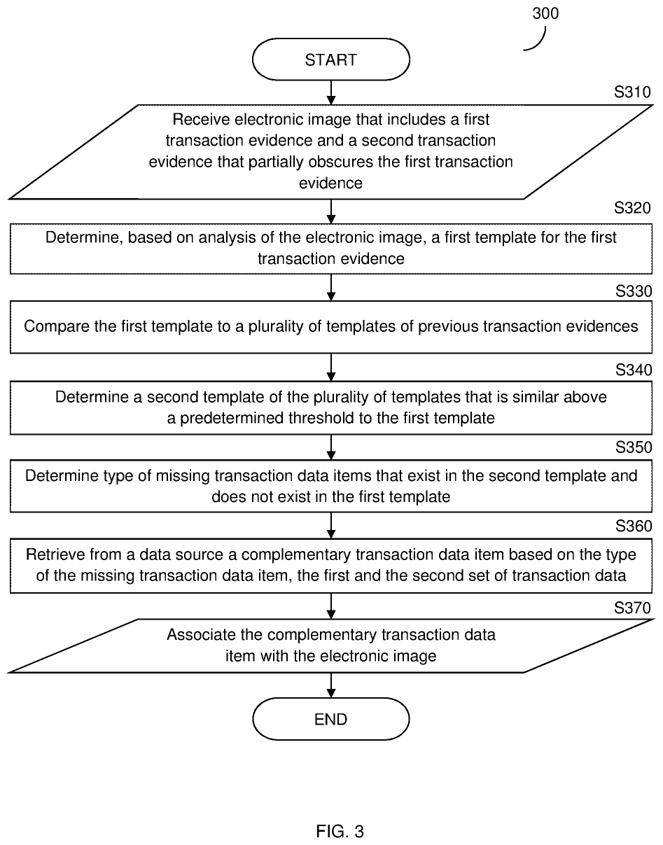

FIG. 3 is an example flowchart 300 illustrating a method for completing missing transaction data items of a transaction evidence that is partially obscured according to an embodiment. In an embodiment, the method may be performed by the server 120 of FIG.

At S310, an electronic image that captures at least a first transaction evidence and at least a second transaction evidence is received. In an embodiment, the electronic image may be extracted from a data repository, e.g. the transaction evidence repository 130. The first transaction evidence is partially but not completely obscured by the second transaction evidence.

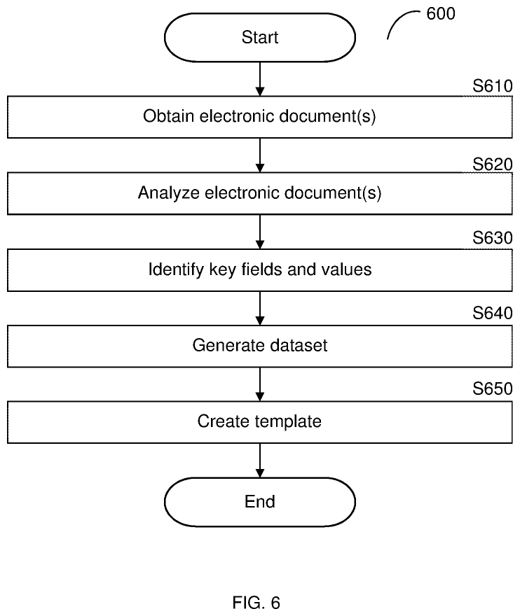

At S320, a first template is determined for the first transaction evidence. The determination of the first template may be achieved by analyzing the electronic image. The analysis may include extracting, using, for example, an optical character recognition (OCR) technique, a first set of transaction data items from the first transaction evidence and a second set of transaction data items from the second transaction evidence. The analysis allows for the differentiation between the first transaction evidence and the second transaction evidence using, for example, a machine learning technique based on the first and second sets of transaction data items. The determination of the first template involves extracting structured data from unstructured or partially structured data, as described further in the discussion relating to FIG. 6 below. In an embodiment, the transaction data items are fields within the transaction evidence, such as vendor name, a client name, a vendor address, a transaction amount, and the like.

At S330, the first template is compared to a plurality of templates of previous transaction evidences. The previous transaction evidences may be retrieved from a database, e.g. the database 140 or transaction evidence repository 130 of FIG. 1. Each of the plurality of templates is associated with one or more entities.

At S340, a second template of the plurality of templates that is similar above a predetermined threshold to the first template is determined. For example, if the first template contains 8 fields, it may be determined that a similar template is a template sharing at least 6 of those 8 fields. The threshold, e.g., 6 of 8 matching fields, may be set manually, e.g., by a user, or automatically, e.g., by a machine learning technique to determine an ideal threshold.

At S350, at least a type of a missing transaction data item that exists in the second template and missing from the first template is determined.

At S360, at least a complementary transaction data item is retrieved from at least a data source based on the type of the missing transaction data item, the first set of transaction data items and the second set of transaction data items.

At S370, the at least a complementary transaction data item is associated with the electronic image.

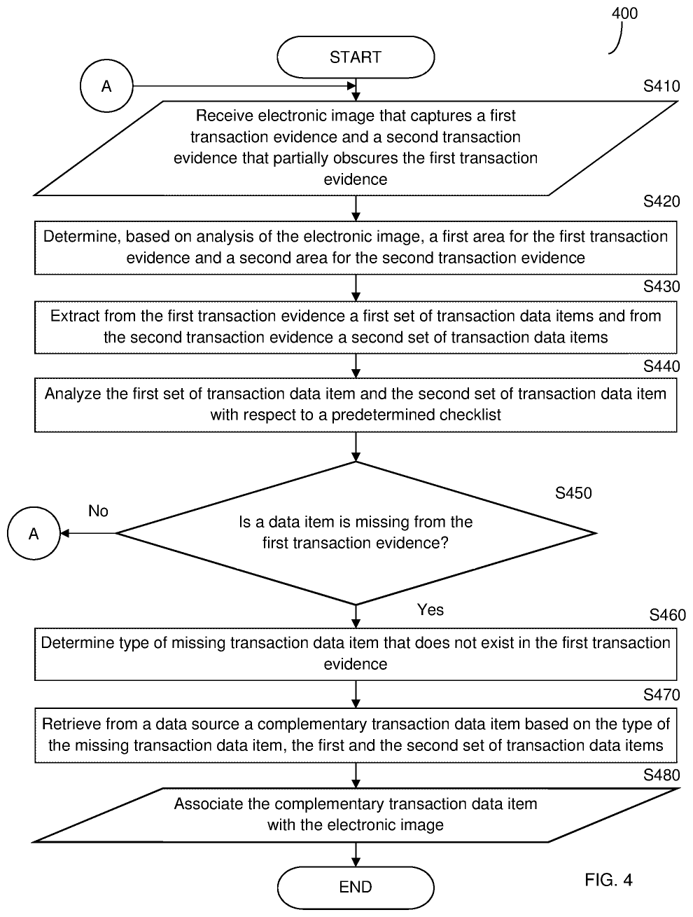

FIG. 4 is an example flowchart 400 illustrating an alternative method for automatically completing missing transaction data items of a first transaction evidence that is partially obscured by a second transaction evidence according to an embodiment.

At S410, an electronic image that captures at least a first transaction evidence and at least a second transaction evidence is received. In an embodiment, the electronic image may be extracted from a data repository, e.g., the transaction evidence repository 130. The first transaction evidence is partially, but not completely obscured by the second transaction evidence. The first transaction evidence may be for example an invoice, a tax receipt, and so on. The second transaction evidence may be, for example, a credit card slip that in many cases is attached to the first evidence such that it obscures a portion of the information of the first evidence.

At S420, a first area that is associated with the first transaction evidence and a second area that is associated with the second transaction evidence are determined. The determination may be achieved using, for example, computer vision techniques, machine learning techniques, optical character recognition (OCR), and the like, to differentiate between the first transaction evidence and the second transaction evidence. The machine learning techniques may include deep learning, neural networks, such as deep convolutional neural network, recurrent neural networks, decision tree learning, Bayesian networks, clustering, and the like.

At S430, a first set of transaction data items is extracted from the first transaction evidence and a second set of transaction data items is extracted from the second transaction evidence. The extraction may be achieved using, for example, OCR or machine learning techniques.

At S440, the first set of transaction data item and the second set of transaction data item are analyzed with respect to a predetermined checklist. The predetermined checklist may include a plurality of items that must appear on a transaction evidence in order to, for example, legally get a full value added tax (VAT) reclaim for a certain transaction. That is, all transaction data items that appear in the electronic image, i.e., from the first and the second transaction evidences, are gathered and compared to a list that contains the types of data items that must be included in a first transaction evidence. In an embodiment, the predetermined checklist is retrieved from a database, an external taxing authority, e.g., an internal revenue website, and the like.

At S450, it is determined whether one or more transaction data items are missing from the first transaction evidence and if so, execution continues with S460; otherwise, execution continues with S410.

At S460, at least a type of a missing transaction data item that does not exist in the first transaction evidence is determined.

At S470, at least a complementary transaction data item is retrieved from at least a data source based on the type of the missing transaction data item, the first set of transaction data items and the second set of transaction data items. As an example, the missing transaction data item may be identified as the address of a specific vendor that was obscured from the first reference and not present in the second reference. Details about that specific vendor can be retrieved, e.g., from a transaction evidence repository. The vendor can be identified from the first and second transaction data items, for example by the vendor, vendor ID number, tax ID number, and the like that are not missing for one or both of evidences. Once identified, the address of the vendor can then be retrieved from the repository.

At S480, the at least a complementary transaction data item is associated with the electronic image.

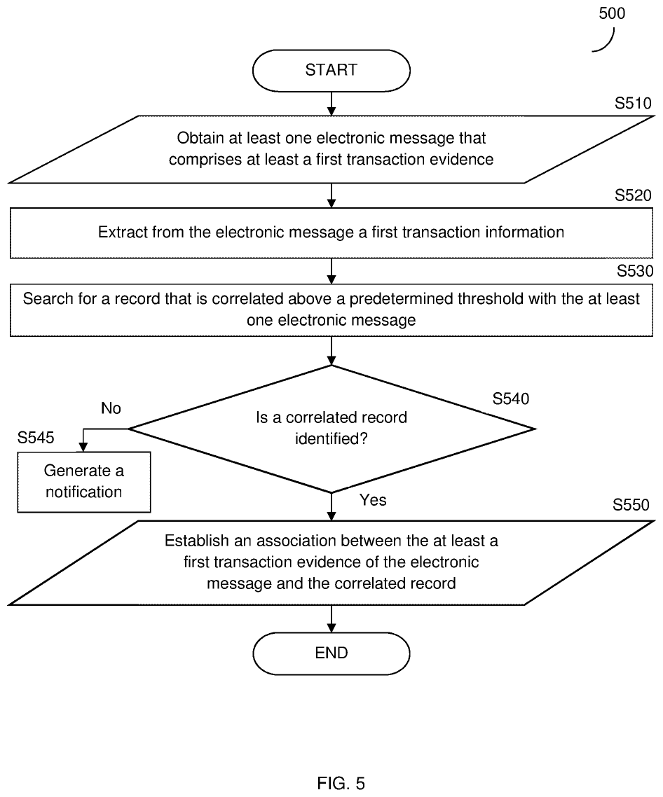

FIG. 5 is an example flowchart 500 illustrating a method for associating a first transaction evidence stored in an electronic message to a correlated record according to an embodiment. In an embodiment, the method may be performed by the server 120 of FIGS. 1 and 2.

At S510, at least one electronic message that includes at least a first transaction evidence is obtained.

At S520, the electronic message is processed for the purpose of electronically extracting therefrom a first transaction information. The extraction may further include the steps of retrieving a first set of data items from the at least a first transaction evidence and retrieving metadata associated with the electronic message.

At S530, a search is performed, in at least an electronic source that contains a plurality of records, for at least one transaction record that is correlated above a predetermined threshold with the electronic message. The search may be achieved by comparing the extracted first transaction information to at least a second information that is associated with each of the plurality of records.

At S540, it is checked whether a correlated record has been identified, and if so, execution continues with S550; otherwise, execution continues with S545.

At optional S545, where a correlated record was not identified, a notification is generated and may be sent automatically to a predetermined user device (not shown). The notification may include an automatic message with an alert regarding at least one transaction evidence that was received via an electronic image, to which a correlated record was not found.

At S550, an association is established between the first transaction evidence of the electronic message and the correlated record upon the determination of a correlation that is above the predetermined threshold.

FIG. 6 is an example flowchart 600 illustrating a method for creating a structured dataset template based on an electronic document according to an embodiment. The structured template may be created based on semi-structured or unstructured data, e.g., semi-structured or unstructured data from the electronic image of a first or a second transaction evidence.

At S610, the electronic document is obtained. Obtaining the electronic document may include, but is not limited to, receiving the electronic document (e.g., receiving a scanned image) or retrieving the electronic document (e.g., retrieving the electronic document from an enterprise system, a merchant enterprise system, or a database).

At S620, the electronic document is analyzed. The analysis may include, but is not limited to, using optical character recognition (OCR) to determine characters in the electronic document.

At S630, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “12112005”, the cleaning process will convert this data to Dec. 12, 2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, determining correlations with previously analyzed invoices, or a combination thereof. Examples for external systems and databases may include business directories, Universal Product Code (UPC) databases, parcel delivery and tracking systems, and so on. In an embodiment, S630 results in a complete set of the predefined key fields and their respective values.

At S640, a structured dataset is generated. The generated structured dataset includes the identified key fields and values.

At S650, based on the structured dataset, a template is created. The created template is a data structure including a plurality of fields and corresponding values. The corresponding values include transaction parameters identified in the structured dataset. The fields may be predefined.

In an embodiment, creating the template includes analyzing the structured dataset to identify transaction parameters such as, but not limited to, at least one entity identifier (e.g., a consumer enterprise identifier, a merchant enterprise identifier, or both), information related to the transaction (e.g., a date, a time, a price, a type of good or service sold, and so on), or both. In a further embodiment, analyzing the structured dataset may also include identifying the transaction based on the structured dataset.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images. In an embodiment, the dataset may represent data relating to tax information, such as the tax status of various vendors within a tax jurisdiction, and transactions associated with such vendors.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for completing missing transaction data items, comprising:
determining a first template for a first transaction evidence based on an analysis of an electronic image, wherein the electronic image includes at least the first transaction evidence and a second transaction evidence, wherein the first transaction evidence is partially obscured by the second transaction evidence;
comparing the first template to a plurality of templates of previous transaction evidences;
determining, based on the comparison, at least a second template of the plurality of templates that is similar to the first template above a predetermined threshold;
determining at least a type of a missing transaction data item (TDI) that exists in the second template and does not exist in the first template;
retrieving at least a complementary TDI based on at least the determined type of the missing TDI; and
associating the at least a complementary TDI with the electronic image.

2. The method of claim 1, wherein the analysis of the electronic image includes extracting a first set of TDIs from the first transaction evidence and a second set of TDIs from the second transaction evidence, wherein the first set of TDIs and the second set of TDIs are fields within a transaction evidence.

3. The method of claim 2, wherein the complementary TDI is further retrieved based on the first set of TDIs and the second set of TDIs.

4. The method of claim 1, wherein the complementary TDI is retrieved from at least one data source containing information related to payment transactions.

5. The method of claim 1, wherein the TDI is determined using at least one of: optical character recognition (OCR) techniques and machine learning techniques.

6. The method of claim 1, further comprising:
determining at least a portion of a region of interest (ROI) that exists in the second template and that is missing from the first template, wherein the comparison of the first template to the plurality of templates is based on ROI identification.

7. The method of claim 1, further comprising:
creating a structured dataset based on the electronic image.

8. The method of claim 7, wherein the electronic image includes at least one of:
structured data, semi-structured data, and unstructured data.

9. The method of claim 1, further comprising:
retrieving a first set of data items and metadata from the electronic image;
searching the plurality of templates of previous transaction evidences for at least one record that is correlated above a predetermined threshold with the at least one electronic image; and
establishing an electronic association between the at least a first transaction evidence of the electronic image and the at least one correlated record upon the determination of a correlation that is above the predetermined threshold.

10. A non-transitory computer readable medium having stored thereon instructions for causing a processing circuitry to perform a process, the process comprising:
determining a first template for a first transaction evidence based on an analysis of an electronic image, wherein the electronic image includes at least the first transaction evidence and a second transaction evidence, wherein the first transaction evidence is partially obscured by the second transaction evidence;
comparing the first template to a plurality of templates of previous transaction evidences;
determining, based on the comparison, at least a second template of the plurality of templates that is similar to the first template above a predetermined threshold;
determining at least a type of a missing transaction data item (TDI) that exists in the second template and does not exist in the first template;
retrieving at least a complementary TDI based on at least the determined type of the missing TDI; and
associating the at least a complementary TDI with the electronic image.

11. A system for completing missing transaction data items, comprising:
a processing circuitry; and
a memory, the memory containing instructions that, when executed by the processing circuitry, configure the system to:
determine a first template for a first transaction evidence based on an analysis of an electronic image, wherein the electronic image includes at least the first transaction evidence and a second transaction evidence, wherein the first transaction evidence is partially obscured by the second transaction evidence;
compare the first template to a plurality of templates of previous transaction evidences;
determine, based on the comparison, at least a second template of the plurality of templates that is similar to the first template above a predetermined threshold;
determine at least a type of a missing transaction data item (TDI) that exists in the second template and does not exist in the first template;
retrieve at least a complementary TDI based on at least the determined type of the missing TDI; and
associate the at least a complementary TDI with the electronic image.

12. The system of claim 11, wherein the analysis of the electronic image includes extracting a first set of TDIs from the first transaction evidence and a second set of TDIs from the second transaction evidence, wherein the first set of TDIs and the second set of TDIs are fields within a transaction evidence.

13. The system of claim 12, wherein the complementary TDI is further retrieved based on the first set of TDIs and the second set of TDIs.

14. The system of claim 11, wherein the complementary TDI is retrieved from at least one data source containing information related to payment transactions.

15. The system of claim 11, wherein the TDI is determined using at least one of: optical character recognition (OCR) techniques and machine learning techniques.

16. The system of claim 11, wherein the system if further configured to:
determine at least a portion of a region of interest (ROI) that exists in the second template and that is missing from the first template, wherein the comparison of the first template to the plurality of templates is based on ROI identification.

17. The system of claim 11, wherein the system if further configured to:
create a structured dataset based on the electronic image.

18. The system of claim 17, wherein the electronic image includes at least one of:
structured data, semi-structured data, and unstructured data.

19. The system of claim 11, wherein the system if further configured to:
retrieve a first set of data items and metadata from the electronic image;
searching the plurality of templates of previous transaction evidences for at least one record that is correlated above a predetermined threshold with the at least one electronic image; and
establishing an electronic association between the at least a first transaction evidence of the electronic image and the at least one correlated record upon the determination of a correlation that is above the predetermined threshold.
